(19) United States
(12) Patent Application Publication
(10) Pub. No.: US 2026/0131804 A1
(43) Pub. Date: May 14, 2026

(54) CHASSIS DOMAIN CONTROLLER FOR AUTOMATED DRIVING, AND CONTROL METHOD AND VEHICLE

(71) Applicant: TSINGHUA UNIVERSITY, Beijing (CN)

(72) Inventors: Chengkun HE, Beijing (CN); Junzhi ZHANG, Beijing (CN); Ruihai MA, Beijing (CN); Junfeng ZHANG, Beijing (CN)

(21) Appl. No.: 19/124,639

(22) PCT Filed: Oct. 27, 2022
(86) PCT No.: PCT/CN2022/127915

§ 371 Date: Apr. 25, 2025

(30) Foreign Application Priority Data
Oct. 26, 2022 (CN) 202211314900.4

(51) Int. Cl. B60W 50/029; B60W 40/06; B60W 60/00

(52) U.S. Cl. CPC B60W 50/029; B60W 40/06; B60W 60/0016; B60W 2050/0292

(57) ABSTRACT

A chassis domain controller for automated driving includes a state estimation and prediction module configured to receive and process sensor signals to compute an extreme vehicle state signal; a safety state machine module, configured to determine whether the autonomous driving domain is operating normally and transmit an autonomous driving degradation signal; while also determining whether the vehicle has entered an extreme dynamic control state. An autonomous driving redundancy module, configured to selectively activate based on the autonomous driving degradation signal; a trajectory tracking control module, configured to receive a trajectory signal and generate longitudinal and lateral motion control signals in combination with the received extreme vehicle state signal; a chassis dynamics control module, configured to receive the longitudinal and lateral motion control signals and generate control signals for individual vehicle components in combination with the received extreme vehicle state signal, transmitting them to the actuator controllers within the respective components.

### RELATED APPLICATIONS

The present application is a U.S. National Phase of International Application Number PCT/CN2022/127915 filed Oct. 27, 2022, which claims priority to Chinese Application Number 202211314900.4 filed Oct. 26, 2022.

### TECHNICAL FIELD

The present disclosure relates to the automotive technology field, and more particularly, to a chassis domain controller for automated driving, a control method, and a vehicle.

### BACKGROUND

With the progressive enhancement of autonomous driving capabilities and the centralization of electronic-electrical architectures in vehicles, the adoption of domain controllers in chassis systems has emerged as a clear technical trend. The design of chassis domain controllers has increasingly become a focal point of academic and industrial research.

Current solutions for chassis domain control in autonomous vehicles primarily follow motion control signals from autonomous driving domain controllers. However, two critical issues persist: Lack of Redundancy in Safety-Critical Systems: The chassis control system does not incorporate redundancy backups for the autonomous driving minimum viable system. In the event of complete failure of the autonomous driving domain controller, manual driver takeover becomes necessary, introducing potential safety risks during the transition phase. Suboptimal control authority in extreme conditions: when encountering extreme dynamic scenarios such as icy road surfaces, control is unilaterally relinquished to extreme dynamic controllers (e.g., ABS brake controllers). This preemptive control mode not only deprives the autonomous driving domain controller of vehicle control authority until active safety systems disengage but also fails to leverage the advanced sensing and decision-making capabilities of autonomous systems to enhance active safety control. Such unilateral control preemption mechanisms may lead to unforeseen safety hazards while underutilizing the synergistic potential between autonomous driving and active safety systems.

### SUMMARY

In response to the aforementioned problems, the objective of the present disclosure is to provide a chassis domain controller for automated driving, a control method, and a vehicle, so as to realize a minimum backup system for autonomous driving in the chassis domain. This system achieves coordinated control between the autonomous driving domain controller and the chassis domain controller under extreme dynamic control conditions such as entering an icy or snowy road surface, thereby enhancing the vehicle's safety performance.

In order to achieve the above objective, the present disclosure adopts the following technical solutions: a chassis domain controller for automated driving, comprising: a state estimation and prediction module configured to receive and process various received sensor signals to calculate extreme vehicle state signals; a safety state machine module configured to determine whether the autonomous driving domain is operating normally based on received verification signals and send autonomous driving degradation signals; simultaneously, it determines whether the vehicle has entered an extreme dynamic control state based on the received extreme vehicle state signals, and if so, sends extreme vehicle state signals to the autonomous driving domain controller; an autonomous driving redundancy module configured to select whether to activate based on the received autonomous driving degradation signals and generate emergency stop trajectory signals; a trajectory tracking control module configured to receive normal operating condition local trajectory signals, emergency stop trajectory signals, and extreme operating condition trajectory signals, and generate longitudinal and lateral motion control signals in combination with the received extreme vehicle state signals transmitted from the state estimation and prediction module; and a chassis dynamics control module configured to receive longitudinal and lateral motion control signals, generate control signals for various actuators of the vehicle in combination with the received extreme vehicle state signals, and send them to corresponding actuator controllers.

Furthermore, in the state estimation and prediction module, signals of vehicle position, attitude, and speed are obtained through fusion calculations using Kalman filter, extended Kalman filter, or Monte Carlo methods, which are further used to calculate the vehicle's extreme state signals.

Moreover, in the safety state machine module, safety state determinations are made on the received extreme vehicle state signals. Based on the verification signals sent by the autonomous driving domain controller of the received vehicle, it determines whether the autonomous driving domain is operating normally and sends autonomous driving degradation signals to the autonomous driving redundancy module.

Additionally, the autonomous driving redundancy module is pre-equipped with redundant perception and decision-making capabilities, including fusion perception algorithms based on degraded sensor signals, and the generation of emergency stop trajectories or minimum risk strategy trajectories based on redundant scene maps.

Furthermore, in the autonomous driving redundancy module, it is determined whether to activate based on the autonomous driving degradation signal. When the degradation signal indicates that the autonomous driving domain controller is normal, it chooses not to activate. When the degradation signal indicates a failure of the autonomous driving domain controller, it activates the redundancy module to generate emergency stop trajectory signals.

In the trajectory tracking controller module, it receives trajectory signals sent by the autonomous driving domain controller and the autonomous driving redundancy module. It determines whether to prioritize the trajectory signals from the autonomous driving redundancy module based on whether emergency stop trajectory signals from the autonomous driving redundancy module are received. According to the selected response trajectory, combined with the position, attitude, and speed signals fed back by the state estimation and prediction module, it generates longitudinal and lateral motion control signals and sends them to the chassis dynamics control module.

A vehicle, installed with a sensor suite supporting high-level autonomous driving, the aforementioned chassis domain controller for automated driving, the vehicle's autonomous driving domain controller, a drive system, a braking system, a steering system, and a suspension system on the vehicle;

the sensor suite supporting high-level autonomous driving transmits various sensor signals to the chassis domain controller and the autonomous driving domain controller respectively; information interaction is performed between the autonomous driving domain controller and the chassis domain controller through a communication link;

the autonomous driving domain controller transmits output control signals to the drive system, the braking system, the steering system, and the suspension system respectively;

the chassis domain controller transmits control signals of the drive system, the braking system, the steering system, and the suspension system to actuators controllers in the drive system, the braking system, the steering system, and the suspension system, thereby realizing driving of the vehicle.

A control method based on the aforementioned vehicle, comprising:

the autonomous driving domain controller calculating the vehicle's driving behavior through a planning and decision-making algorithm and generating trajectory signals, which are transmitted to the chassis domain controller together with verification signals for state determination and trajectory tracking control.

Further, when generating trajectory signals, the autonomous driving domain controller determines whether the vehicle has entered a vehicle extreme dynamic control state, whether emergency stopping is needed, and whether it has the capability of precise control under extreme conditions, based on the extreme vehicle state signals sent by the received chassis domain controller;

when the vehicle needs to stop urgently, the autonomous driving domain controller sends emergency stop trajectory signals to the chassis domain controller;

when the vehicle has not entered an extreme dynamic control state and does not need to stop urgently, the autonomous driving domain controller sends local trajectory signals to the chassis domain controller;

when the vehicle has entered an extreme dynamic control state and has the capability of precise control under extreme conditions, the autonomous driving domain controller sends extreme condition trajectory signals to the chassis domain controller;

when the vehicle has entered an extreme dynamic control state but does not have the capability of precise control under extreme conditions, the autonomous driving domain controller sends local trajectory signals to the chassis domain controller.

Further, when the autonomous driving domain controller determines that the chassis domain controller has failed based on the verification signals received from the chassis domain controller, it directly generates control commands for each actuator in the vehicle based on the received multiple sensor signals, and transmits them to the corresponding actuator controllers through an independent communication link to implement direct control;

when the chassis domain controller determines that the autonomous driving domain controller has failed based on the verification signals received from the autonomous driving domain controller, the state estimation and prediction module of the chassis domain controller performs fusion calculations based on the received multiple sensor signals to estimate and predict the vehicle's position, attitude, and speed information, and calculates extreme state signals in combination with the vehicle dynamics model.

A control method for a chassis domain controller oriented towards autonomous driving, comprising:

the chassis domain controller determining whether the autonomous driving domain controller is operating normally based on the verification signals received from the autonomous driving domain controller, and sending autonomous driving degradation signals; simultaneously performing fusion calculations based on the received multiple sensor signals to estimate and predict the vehicle's position, attitude, and speed information, and calculating extreme state signals in combination with the vehicle dynamics model;

determinating whether the vehicle has entered an extreme dynamic control state, and if so, sending extreme vehicle state signals to the autonomous driving domain controller; and selecting whether to activate and generate emergency stop trajectory signals based on the received autonomous driving degradation signals;

generating longitudinal and lateral motion control signals based on normal condition local trajectory signals, emergency stop trajectory signals, extreme condition trajectory signals, and in combination with extreme vehicle state signals;

generating control signals for each vehicle actuator based on the longitudinal and lateral motion control signals, in combination with the extreme vehicle state signals, and sending them to the corresponding actuator controllers.

Due to the adoption of the above technical solution, the present disclosure has the following advantages.

The present disclosure can realize a minimum system for chassis domain backup autonomous driving, achieving collaborative control between the autonomous driving domain controller and the chassis domain controller under extreme dynamic control conditions such as entering icy roads, thereby enhancing the vehicle's safety performance.

### BRIEF DESCRIPTION OF THE DRAWINGS

FIG. 1 is a schematic diagram of a vehicle oriented towards autonomous driving provided by an embodiment of the present disclosure;

FIG. 2 is a schematic diagram of a chassis domain controller oriented towards autonomous driving provided by an embodiment of the present disclosure;

FIG. 3 is a schematic diagram of a control architecture oriented towards autonomous driving provided by an embodiment of the present disclosure;

FIG. 4 is a schematic diagram of a control framework when there is no fault provided by an embodiment of the present disclosure;

FIG. 5 is a schematic diagram of a control framework when there is a fault in the chassis domain controller provided by an embodiment of the present disclosure; and

FIG. 6 is a schematic diagram of a control framework when there is a fault in the autonomous driving domain controller provided by an embodiment of the present disclosure.

### DETAILED DESCRIPTION

In order to make the purpose, technical solution, and advantages of the embodiments of the present disclosure clearer, the technical solution of the embodiments of the present disclosure will be described clearly and completely below with reference to the drawings of the embodiments of the present disclosure. It is apparent that the described embodiments are a part of the embodiments of the present disclosure, rather than all of the embodiments. All other embodiments obtained by those of ordinary skill in the art based on the described embodiments of the present disclosure fall within the scope of protection of the present disclosure.

It should be noted that the terms used here are for describing specific implementation methods only, and are not intended to limit the exemplary implementation methods according to this application. As used herein, unless otherwise explicitly indicated by the context, singular forms are also intended to include plural forms. Furthermore, it should be understood that when the terms “comprises” and/or “includes” are used in this specification, they indicate the presence of features, steps, operations, devices, components, and/or combinations thereof.

The main solution for current autonomous driving vehicle chassis domain control is to follow the motion control signals of the autonomous driving domain controller. There are two problems: on the one hand, the control system of the chassis domain has not redundantly backed up the minimum autonomous driving system; on the other hand, when the vehicle enters extreme dynamic conditions such as icy roads, the chassis part takes over completely, and the autonomous driving domain controller completely loses its control over the vehicle. In this regard, the present disclosure provides a chassis domain controller, a control method, and a vehicle oriented towards autonomous driving, to realize a minimum autonomous driving system backed up by the chassis domain, and to achieve collaborative control between the autonomous driving domain controller and the chassis domain controller when entering extreme dynamic control conditions such as icy roads, thereby enhancing the vehicle's safety performance.

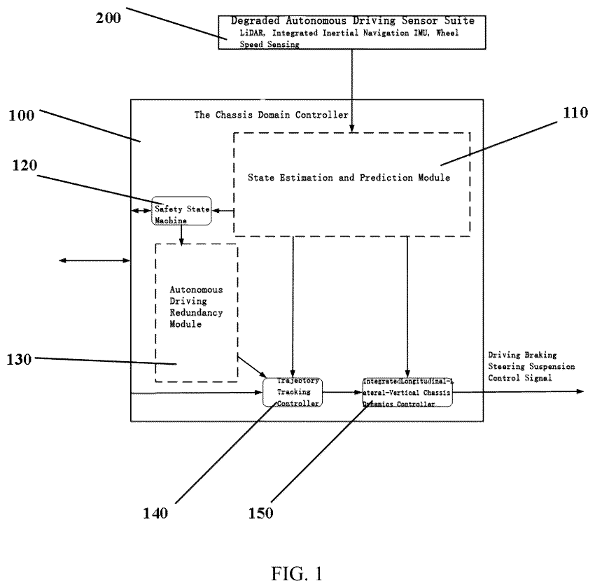

In an embodiment of the present disclosure, a chassis domain controller oriented towards autonomous driving is provided. In this embodiment, as shown in FIG. 1, the chassis domain controller 100 includes:

state estimation and prediction module 110, configured to receive and process multiple sensor signals to calculate and obtain extreme vehicle state signals;

safety state machine module 120, configured to determine whether the autonomous driving domain is operating normally based on received verification signals, and send autonomous driving degradation signals; and at the same time, determine whether the vehicle has entered an extreme dynamic control state based on the received extreme vehicle state signals, and if so, send extreme vehicle state signals to the autonomous driving domain controller 300;

autonomous driving redundancy module 130, configured to determine whether to activate based on the received autonomous driving degradation signals, and generate emergency stop trajectory signals;

trajectory tracking control module 140, configured to receive normal operating condition local trajectory signals, emergency stop trajectory signals, and extreme operating condition trajectory signals, and combine them with the received extreme vehicle state signals transmitted from the state estimation and prediction module 110 to generate longitudinal and lateral motion control signals;

chassis dynamics control module 150, configured to receive the longitudinal and lateral motion control signals, and combine them with the received extreme vehicle state signals transmitted from the state estimation and prediction module 110 to generate control signals for each vehicle actuator, and send them to the corresponding actuator controller.

In the above embodiment, in the state estimation and prediction module 110, the received multiple sensor signals are fused and calculated using methods such as Kalman filtering, extended Kalman filtering, or Monte Carlo to obtain signals of vehicle position, attitude, and speed. Based on these signals, extreme vehicle state signals are calculated, such as wheel slip rate status. The obtained position, attitude, and speed signals are sent to the trajectory tracking control module 140 and the safety state machine module 120, and the calculated extreme vehicle state signals are sent to the chassis dynamics control module 150 and the safety state machine module 120.

The extreme vehicle state signals comprise anti-slip flag signals, anti-lock braking flag signals, vehicle stability control flag signals, vehicle yaw rate, center of mass sideslip angle signals, wheel slip rate signals, wheel sideslip angles, etc. They also comprise status signals indicating whether the vehicle has the ability to precisely control the braking force, driving force, and steering torque of each wheel in extreme states.

The multiple sensor signals comprise wheel sensor signals collected and processed by the chassis domain controller, gyroscope vehicle longitudinal, lateral, and vertical acceleration signals, GNSS signals, and integrated inertial navigation IMU, as well as lidar positioning signals from the autonomous driving domain controller.

In the above embodiment, in the safety state machine module 120, the safety state of the vehicle state signals is determined based on the received signals, and verification signals sent by the autonomous driving domain controller 300 in the vehicle are received. The verification signals can be pre-agreed status values or timing signals, etc. The verification signals are decoded to determine whether the autonomous driving domain is operating normally, and autonomous driving degradation signals are sent to the autonomous driving redundancy module 130. The degradation signals comprise fault status or normal status, etc. In addition, extreme vehicle state signals and verification signals are also sent to the autonomous driving domain controller 300 of the vehicle.

In this embodiment, the safety state machine module can also determinate the healthy operating status of the vehicle state estimation module based on the received signals, and send the determination results to the autonomous driving domain controller.

In the above embodiment, in the autonomous driving redundancy module 130, degraded autonomous driving sensor signals are received, and based on the autonomous driving degradation signals, for example, when the degradation signals indicate that the autonomous driving domain controller is normal, the autonomous driving redundancy module 130 may not be activated. When the degradation signals indicate a fault in the autonomous driving domain controller, the redundant perception and decision-making algorithms in the autonomous driving redundancy module 130 are selected to be enabled, emergency stop trajectory signals are generated, and the emergency stop trajectory signals are sent to the trajectory tracking controller module 140 when degradation occurs.

The redundant perception and decision-making pre-set in the autonomous driving redundancy module comprises fusion perception algorithms based on degraded sensor signals, and generation of emergency stop trajectories or minimum risk strategy trajectories based on redundant scene maps. The redundant scene map can be constructed by the autonomous driving redundancy module, or can be backed up and updated from the autonomous driving domain controller.

In this embodiment, the degraded autonomous driving sensor signals of the autonomous driving redundancy module 130 comprise a lidar, an integrated inertial navigation IMU, and independently powered backup cameras.

In the aforementioned embodiment, the Trajectory Tracking Controller Module 140 receives trajectory signals such as local trajectories or extreme condition trajectories transmitted by the Autonomous Driving Domain Controller 300 and the Autonomous Driving Redundancy Module 130. It determines whether to prioritize the trajectory signals from the Autonomous Driving Redundancy Module 130 based on whether an emergency stop trajectory signal is received. According to the selected response trajectory, combined with feedback signals such as position from the State Estimation and Prediction Module 110, longitudinal and lateral motion control signals are generated and sent to the Chassis Dynamics Control Module 150.

The Trajectory Tracking Controller Module comprises a Nearest Trajectory Following Controller, a Curvature Controller, and a Longitudinal/Lateral Speed Controller. The Nearest Trajectory Following Controller controls the vehicle to steer towards the nearest position point in the received trajectory signal based on the vehicle's actual position information, generating target driving curvature, target longitudinal speed, and target lateral speed. The Curvature Controller and Longitudinal/Lateral Speed Controller generate longitudinal and lateral motion control signals based on the target driving curvature, target longitudinal speed, target lateral speed, as well as the actual vehicle curvature and actual longitudinal/lateral speeds.

In the aforementioned embodiment, the Chassis Dynamics Control Module 150 receives extreme state signals of the vehicle from the State Estimation and Prediction Module 110 and longitudinal and lateral motion control signals from the Trajectory Tracking Controller Module 140. It generates control signals for each vehicle actuator (including the braking system 401, drive system 400, steering system 402, and suspension system 403) and sends them to the corresponding actuator controllers according to vehicle kinematics and extreme dynamics control algorithms. The extreme dynamics control algorithms can comprise various methods such as Integrated Longitudinal, Lateral, and Vertical Dynamics Control Algorithm, Independent Longitudinal, Lateral, and Vertical Dynamics Control Algorithm, or Integrated Longitudinal and Lateral Dynamics Control Algorithm.

The Chassis Dynamics Control Module 150 comprises integrated longitudinal, lateral, and vertical chassis dynamics control modules, integrated longitudinal and lateral chassis dynamics control modules, or independent longitudinal, lateral, and vertical chassis dynamics control modules.

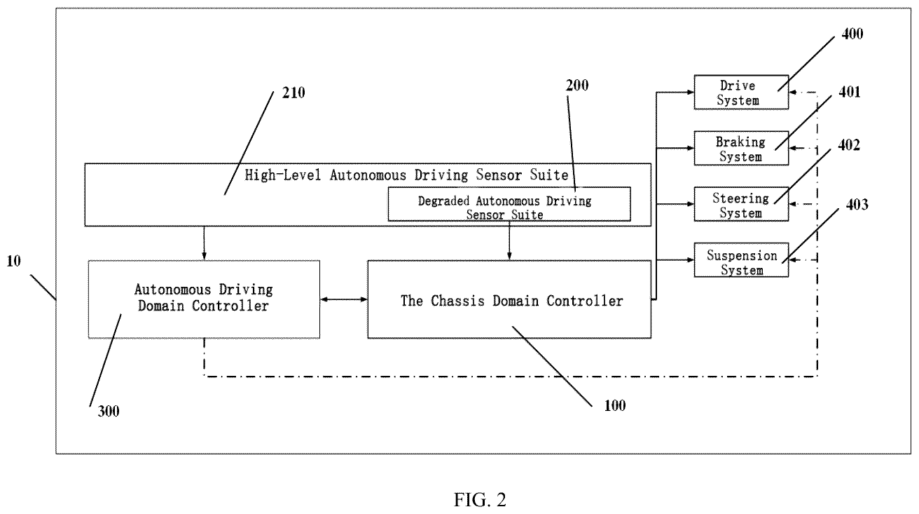

In an embodiment of the present disclosure, a vehicle is provided. As shown in FIG. 2, the vehicle 10 is equipped with the chassis domain controller 100 for autonomous driving, the sensor suite 200 supporting high-level autonomous driving, the autonomous driving domain controller 300, the drive system 400, the braking system 401, the steering system 402, and the suspension system 403 from the aforementioned embodiments. The sensor suite 200 supporting high-level autonomous driving comprises a sensor suite 210 supporting degraded autonomous driving.

The chassis domain controller 100 for autonomous driving can be installed on the vehicle 10. The vehicle 10 can be equipped with a sensor suite 210 supporting high-level autonomous driving, part of which can form a sensor suite 200 supporting degraded autonomous driving. The sensors detect the vehicle's status and environmental information. The sensor suite 210 supporting high-level autonomous driving directly transmits data to the autonomous driving domain controller 300, while the sensor suite 200 supporting degraded autonomous driving directly transmits data to the chassis domain controller. There is a communication link between the autonomous driving domain controller 300 and the chassis domain controller 100, allowing information exchange.

The autonomous driving domain controller 300 has communication links that can directly communicate with the drive system 400, the braking system 401, the steering system 402, and the suspension system 403. The autonomous driving domain controller 300 transmits output control signals to the drive system 400, the braking system 401, the steering system 402, and the suspension system 403 respectively.

The chassis domain controller 100 transmits control signals for the drive system 400, the braking system 401, the steering system 402, and the suspension system 403 to the actuator controllers within these systems, enabling vehicle driving.

In the aforementioned embodiments, various sensor configurations can be installed on the vehicle 10, such as cameras, millimeter-wave radars, ultrasonic radars, LiDARs, IMUs, GNSSs, etc., which can be selected according to actual needs.

In the aforementioned embodiments, the autonomous driving domain controller 300 and the chassis domain controller 100 on the vehicle 10 can switch between each other in case of failure, and can also cooperate or integrate control during extreme dynamics control.

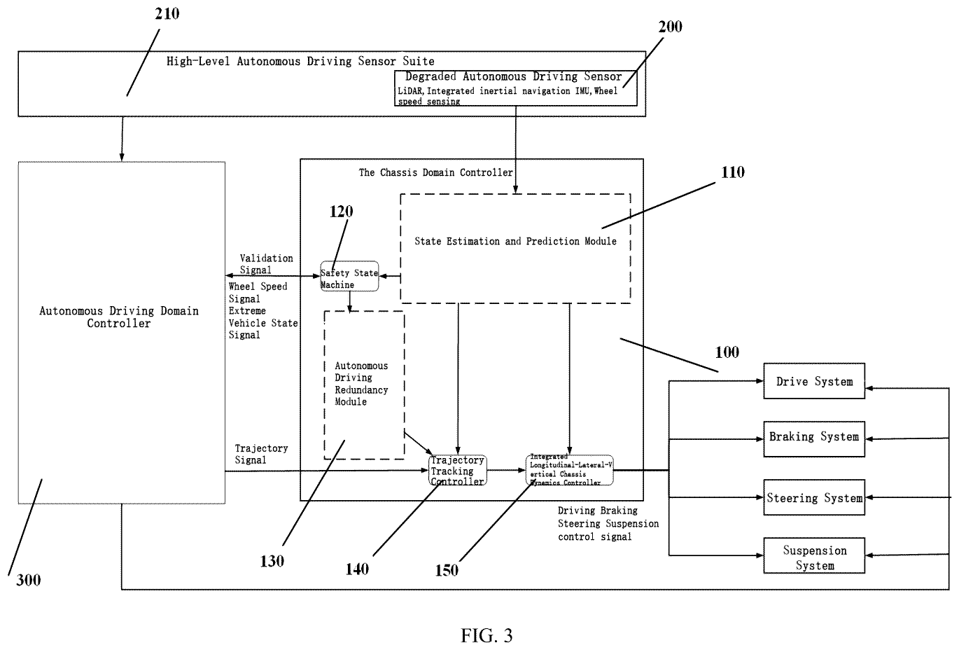

In an embodiment of the present disclosure, a control method with a chassis domain controller is provided, which is implemented based on the vehicle in the aforementioned embodiments. In this embodiment, as shown in FIG. 3, the control method includes the follows.

The autonomous driving domain controller 300 processes multiple sensor signals through a sensor fusion algorithm to construct a scenario map, and integrates vehicle-mounted LiDAR positioning signals. The LiDAR positioning signals can also be transmitted to the chassis domain controller 100 as needed. The autonomous driving domain controller 300 calculates the vehicle's driving behavior through a planning and decision-making algorithm, further generates trajectory signals, and transmits them to the chassis domain controller 100 along with verification signals for state determination and trajectory tracking control.

In this embodiment, the sensor suite signals 210 supporting high-level autonomous driving are transmitted to the autonomous driving domain controller 300, and the sensor suite signals 100 supporting degraded autonomous driving are transmitted to the chassis domain controller. The autonomous driving domain controller 300 generates trajectory signals and transmits them to the trajectory tracking controller 140 of the chassis domain controller 100, generates verification signals and transmits them to the safety state machine module 120 of the chassis domain controller 100. The autonomous driving domain controller 300 has separate communication links and interfaces connected to the drive system 400, the braking system 401, the steering system 402, and the suspension system 403. The autonomous driving domain controller 300 receives wheel speed signals, extreme vehicle state signals, and verification signals from the chassis domain controller 100. The chassis domain controller 100 generates control signals for the vehicle's braking system 401, drive system 400, steering system 402, and suspension system 403 and sends them to the corresponding actuator controllers.

In the aforementioned embodiments, when generating trajectory signals, the autonomous driving domain controller 300 determines whether the vehicle has entered an extreme vehicle dynamics control state, whether emergency stopping is required, and whether precise control under extreme conditions is feasible, based on extreme vehicle state signals received from the chassis domain controller 100, such as drive slip control flag signals, brake anti-lock flag signals, vehicle stability control flag signals, etc.

When emergency stopping is required, the autonomous driving domain controller 300 sends an emergency stop trajectory signal to the chassis domain controller 100.

When the vehicle has not entered an extreme dynamics control state and emergency stopping is not required, the autonomous driving domain controller 300 sends a local trajectory signal to the chassis domain controller 100.

When the vehicle has entered an extreme dynamics control state and has precise control capabilities under extreme conditions, the autonomous driving domain controller 300 sends an extreme condition trajectory signal to the chassis domain controller 100.

When the vehicle has entered an extreme dynamics control state but lacks precise control capabilities under extreme conditions, the autonomous driving domain controller 300 sends a local trajectory signal to the chassis domain controller 100.

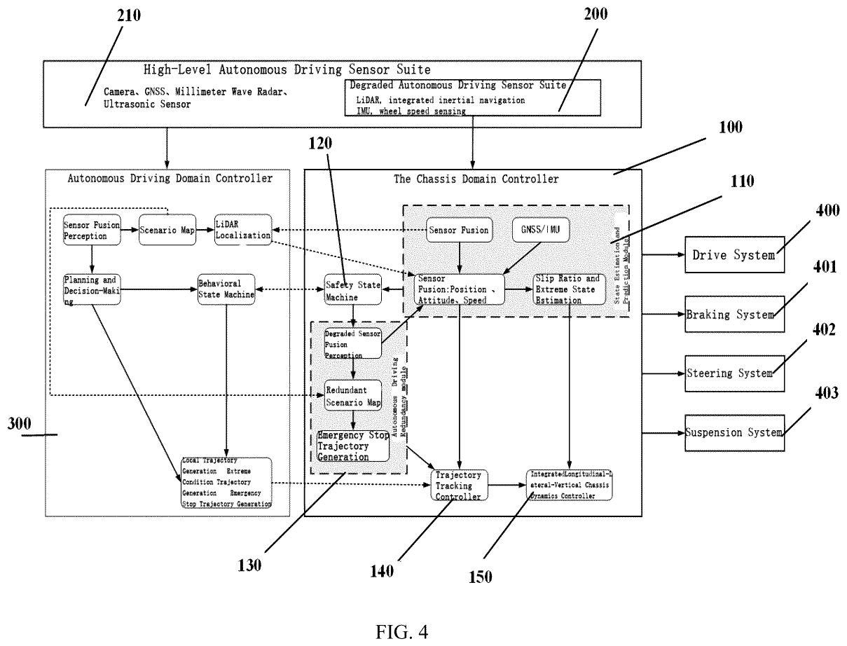

In the aforementioned embodiments, as shown in FIG. 4, when both the autonomous driving domain controller 300 and the chassis domain controller 100 are functioning normally, the sensor suite 210 supporting high-level autonomous driving, such as multiple cameras, GNSS, multiple millimeter-wave radars, multiple ultrasonic radars, etc., transmits data to the autonomous driving domain controller. The sensor suite 200 supporting degraded autonomous driving, such as LiDAR, integrated inertial navigation IMU, wheel speed sensors, etc., transmits data to the chassis domain controller 200. These signals can also be provided in the sensor suite 210 supporting high-level autonomous driving and transmitted to the autonomous driving domain controller 300 as needed.

Here, the state estimation and prediction module 110 of the chassis domain controller 100 estimates and predicts vehicle position, attitude, speed, and other information using methods such as Kalman filtering or Extended Kalman filtering, based on received wheel speed sensor signals, GNSS signals, IMU signals, and possibly LiDAR positioning signals. It further calculates extreme state signals such as wheel slip rate by combining vehicle dynamics models.

The autonomous driving redundancy module 130 of the chassis domain controller 100 receives degraded autonomous driving sensor signals from the safety state machine module 120. When the autonomous driving degradation signal indicates a normal state, the autonomous driving redundancy module 130 enters a silent state.

The trajectory tracking controller module 140 receives local trajectory or extreme condition trajectory signals from the autonomous driving domain controller 300 and the autonomous driving redundancy module 130. In the absence of an emergency stop trajectory signal from the autonomous driving redundancy module 130, it selects the trajectory signal from the autonomous driving domain controller 300 as input, combines feedback signals such as position from the state estimation and prediction module 110, and generates longitudinal and lateral motion control signals which are then sent to the chassis dynamics control module 150.

The chassis dynamics control module 150 receives extreme vehicle state signals from the state estimation and prediction module 110 and longitudinal and lateral motion control signals from the trajectory tracking controller module 140. It generates control signals for the vehicle's braking system 401, drive system 400, steering system 402, and suspension system 403 based on vehicle kinematics and extreme dynamics control algorithms, which can comprise longitudinal-lateral-vertical integrated dynamics control algorithms, longitudinal-lateral-vertical independent dynamics control algorithms, or longitudinal-lateral integrated dynamics control algorithms, and sends them to the corresponding actuator controllers. Different dynamics algorithms can be configured based on various extreme vehicle state signals. For example, when the extreme vehicle state signal indicates no entry into extreme control state, the dynamics control part directly distributes or continues to use motion control signals to each execution system. When the extreme vehicle state signal indicates entry into extreme control state and the chassis execution system lacks precise control capabilities, the dynamics control part directly controls each execution system based on motion control signals as boundaries and actual conditions. When the extreme vehicle state signal indicates entry into extreme control state and the chassis execution system has precise control capabilities, the dynamics control part integrates motion control signals with dynamics algorithms to enhance the precision of dynamics algorithm control and improve safety performance by utilizing more accurate sensor information from the autonomous driving part.

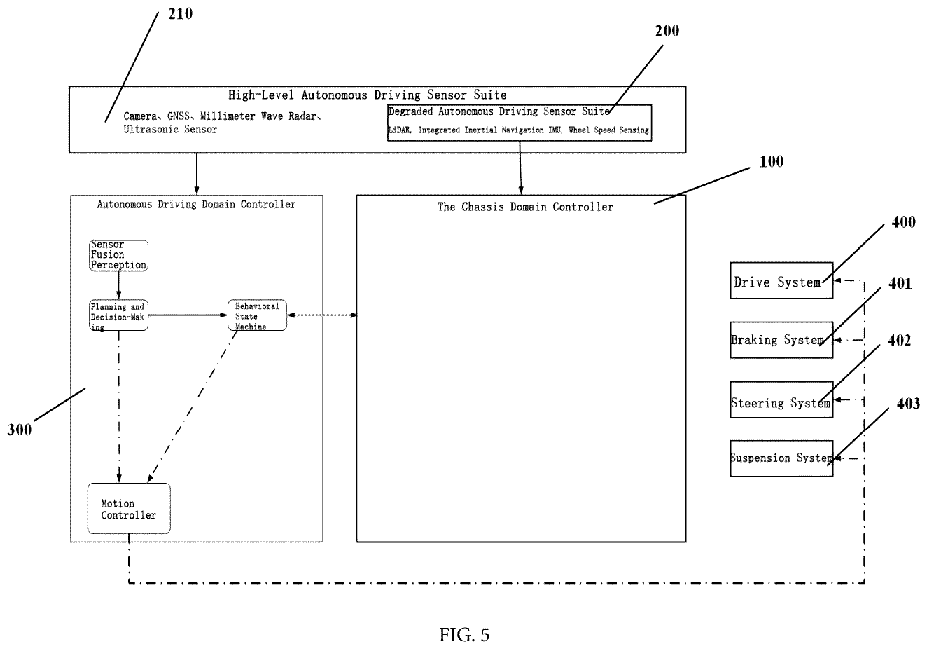

In the aforementioned embodiments, as shown in FIG. 5, when the autonomous driving domain controller 300 determines the fault of chassis domain controller 100 based on the received verification signal from the chassis domain controller 100, it directly generates control commands for actuation systems such as the braking system 401 by integrating multi-sensor signals through sensor fusion algorithms, planning decision-making algorithms, and backup motion control algorithms. These commands are then transmitted to corresponding actuation systems via independent communication links to implement direct control.

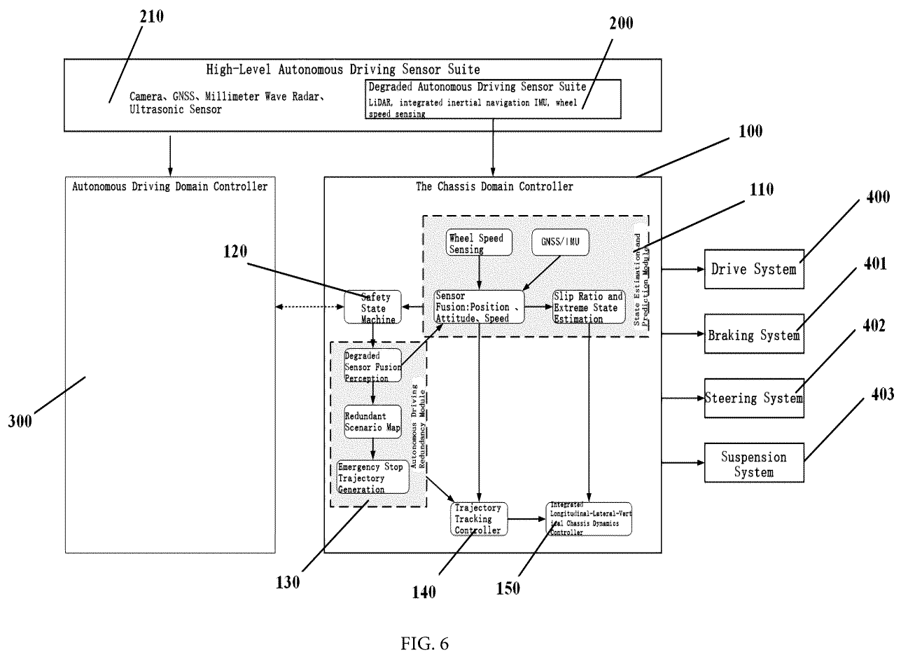

In the aforementioned embodiments, as shown in FIG. 6, when the chassis domain controller 100 determines the fault of autonomous driving domain controller 300 based on the received verification signal from the autonomous driving domain controller 300, the state estimation and prediction module 110 of the chassis domain controller 100 estimates and predicts vehicle position, attitude, speed, and other information by fusing wheel speed sensor signals, GNSS signals, IMU signals, and possible LiDAR positioning signals using methods such as Kalman filtering or extended Kalman filtering. Further, it calculates extreme state signals such as wheel slip rate by combining vehicle dynamic models.

The autonomous driving redundancy module 130 of the chassis domain controller 100 receives degraded autonomous driving sensor signals sent by the safety state machine module 120. When the autonomous driving degradation signal indicates a fault state, the autonomous driving redundancy module 130 is activated to enable redundant perception and decision-making algorithms. It constructs a redundant scenario map or updates a previously synchronized scenario map from the autonomous driving domain controller 300, further calculates and generates emergency stop trajectory signals, and sends these signals to the trajectory tracking controller module 140.

The trajectory tracking controller module 140 receives emergency stop trajectory signals from the autonomous driving redundancy module 130 as input, combines feedback signals such as position from the state estimation and prediction module 110, and generates longitudinal and lateral motion control signals that are sent to the chassis dynamics control module 150.

The chassis dynamics control module 150 receives extreme vehicle state signals from the state estimation and prediction module 110 and longitudinal and lateral motion control signals from the trajectory tracking controller module 140. Based on vehicle kinematics and extreme dynamics control algorithms (which may comprise longitudinal-lateral-vertical integrated dynamics control algorithms, longitudinal-lateral-vertical independent dynamics control algorithms, or longitudinal-lateral integrated dynamics control algorithms), it generates control signals for the vehicle braking system 401, drive system 400, steering system 402, and suspension system 403, which are then sent to corresponding actuators. Different dynamics algorithms can be configured according to extreme vehicle state signals. For example, when extreme state signals indicate non-extreme control conditions, the dynamics control module directly distributes or retains motion control signals to each actuation system. When extreme state signals indicate entry into extreme control conditions, the dynamics control module directly controls each actuation system based on motion control signals as boundaries and actual conditions.

In one embodiment of the present disclosure, a control method for a chassis domain controller oriented towards autonomous driving is provided. The method comprises the following steps.

1) The chassis domain controller 100 determines whether the autonomous driving domain controller 300 is operating normally based on received verification signals from the autonomous driving domain controller 300, sends autonomous driving degradation signals, and performs fusion calculations based on received multi-sensor signals to estimate and predict vehicle position, attitude, and speed information. It further calculates extreme state signals using vehicle dynamic models.

2) It determines whether the vehicle has entered extreme dynamics control conditions. If so, it sends extreme vehicle state signals to the autonomous driving domain controller and selects whether to activate based on received autonomous driving degradation signals to generate emergency stop trajectory signals.

3) It generates longitudinal and lateral motion control signals based on normal operating condition local trajectory signals, emergency stop trajectory signals, extreme condition trajectory signals, and extreme vehicle state signals.

4) It generates control signals for each vehicle actuator based on longitudinal and lateral motion control signals and extreme vehicle state signals, and sends them to corresponding actuator controllers.

In summary, the chassis domain controller of the present disclosure achieves minimal autonomous driving system redundancy through heterogeneous redundancy backup of the chassis domain controller. It provides interfaces for interacting with the autonomous driving domain controller under extreme vehicle dynamics conditions, laying the foundation for autonomous driving domain intervention in extreme dynamics control and improving vehicle safety performance.

Finally, it should be noted that: The above embodiments are merely illustrative of the technical solutions of the present disclosure and are not intended to limit its scope. While the present disclosure has been described in detail with reference to the foregoing embodiments, it should be understood by those of ordinary skill in the art that various modifications or substitutions of technical features may still be made without departing from the spirit and scope of the technical solutions of the present disclosure as defined by the appended claims.

1. A chassis domain controller for automated driving comprising:
state estimation and prediction module configured to receive and process multiple sensor signals to calculate extreme vehicle state signals;
safety state machine module configured to determine normal operation of the autonomous driving domain based on received verification signals and transmits autonomous driving degradation signals; wherein, safety state machine module determines whether the vehicle enters extreme dynamic control state based on received extreme vehicle state signals, and if so, transmits the extreme vehicle state signals to the autonomous driving domain controller;
autonomous driving redundancy module configured to activate based on received autonomous driving degradation signals to generate emergency stop trajectory signals;
trajectory tracking control module configured to receive normal operating condition local trajectory signals, emergency stop trajectory signals, and extreme condition trajectory signals, and combine them with received extreme vehicle state signals from the state estimation and prediction module to generate longitudinal and lateral motion control signals;
chassis dynamics control module configured to receive longitudinal and lateral motion control signals, combine them with received extreme vehicle state signals, generate control signals for each vehicle actuator, and transmit them to corresponding actuator controllers.

2. The chassis domain controller for automated driving as described in claim 1, wherein the state estimation and prediction module employs Kalman filtering, extended Kalman filtering, or Monte Carlo methods to fuse and calculate vehicle position, attitude, and speed signals, further deriving extreme vehicle state signals.

3. The chassis domain controller for automated driving as described in claim 1, wherein the safety state machine module performs safety state evaluation on received extreme vehicle state signals, determines normal operation of the autonomous driving domain based on received verification signals from the vehicle's autonomous driving domain controller, and transmits autonomous driving degradation signals to the autonomous driving redundancy module.

4. The chassis domain controller for automated driving as described in claim 3, wherein the autonomous driving redundancy module contains pre-configured redundant perception and decision-making algorithms, wherein the pre-configured redundant perception and decision-making algorithms comprises fusion perception algorithms based on degraded sensor signals, and generation of emergency stop trajectories or minimum-risk strategy trajectories based on redundant scenario maps.

5. The chassis domain controller for automated driving as described in claim 1, wherein the autonomous driving redundancy module activates based on autonomous driving degradation signals, when the degradation signal indicates normal operation of the autonomous driving domain controller, the autonomous driving redundancy module remains inactive; when the degradation signal indicates failure of the autonomous driving domain controller, the redundancy module activates to generate emergency stop trajectory signals.

6. The chassis domain controller for automated driving as described in claim 1, wherein the trajectory tracking control module receives trajectory signals from both the autonomous driving domain controller and the autonomous driving redundancy module, the trajectory tracking control module prioritizes trajectory signals from the redundancy module if emergency stop trajectory signals are received, and generates longitudinal and lateral motion control signals based on selected trajectories combined with position, attitude, and speed feedback from the state estimation and prediction module, and then transmit them to the chassis dynamics control module.

7. A vehicle, comprising: a sensor suite for supporting high-level autonomous driving mounted on the vehicle, the chassis domain controller for automated driving as described in claim 1, an autonomous driving domain controller, a drive system, a braking system, a steering system, and a suspension system;
the sensor suite for the high-level autonomous driving transmits multiple sensor signals to both the chassis domain controller and the autonomous driving domain controller;
information interaction occurs between the autonomous driving domain controller and the chassis domain controller via communication links;
the autonomous driving domain controller transmits output control signals to the drive system, braking system, steering system, and suspension system;
the chassis domain controller transmits control signals for the drive system, braking system, steering system, and suspension system to their respective actuator controllers to enable vehicle operation.

8. A control method based on the vehicle described in claim 7, the autonomous driving domain controller calculates driving behaviors and generates trajectory signals through planning and decision-making algorithms, transmitting them along with verification signals to the chassis domain controller for state evaluation and trajectory tracking control.

9. The control method as described in claim 8, during trajectory signal generation, the autonomous driving domain controller determines whether the vehicle enters extreme dynamic control state or requires emergency stopping, and whether the vehicle possesses precise control capability under extreme conditions, based on extreme vehicle state signals from the chassis domain controller;
when emergency stopping is required, the autonomous driving domain controller transmits emergency stop trajectory signals to the chassis domain controller;
when the vehicle is not in extreme dynamic control state and does not require emergency stopping, the autonomous driving domain controller transmits local trajectory signals to the chassis domain controller;
when the vehicle enters extreme dynamic control state and possesses precise control capability under extreme conditions, the autonomous driving domain controller transmits extreme condition trajectory signals to the chassis domain controller;
when the vehicle enters extreme dynamic control state but lacks precise control capability under extreme conditions, the autonomous driving domain controller transmits local trajectory signals to the chassis domain controller.

10. The control method as described in claim 8, wherein when the autonomous driving domain controller identifies chassis domain controller failure based on received verification signals, the autonomous driving domain controller directly generates control commands for each vehicle actuator based on received sensor signals and transmits them to corresponding actuator controllers via independent communication links for direct control;
when the chassis domain controller identifies autonomous driving domain controller failure based on received verification signals, the state estimation and prediction module of the chassis domain controller performs fusion calculations on received sensor signals to estimate and predict vehicle position, attitude, and speed information, and further calculates, in combination with vehicle dynamics models to derive extreme state signals.

11. A control method for the chassis domain controller for automated driving comprising:
the chassis domain controller determining, based on a received verification signal from an autonomous driving domain controller, whether the autonomous driving domain controller is operating normally, and sending an autonomous driving degradation signal; simultaneously, performing fusion calculations based on received multiple sensor signals to estimate and predict vehicle position, attitude, and speed information, and further calculating, in combination with a vehicle dynamics model, to obtain extreme state signals;
determining whether the vehicle has entered an extreme dynamics control state and, if so, sending an extreme vehicle state signal to the autonomous driving domain controller; and selecting, based on the received autonomous driving degradation signal, whether to activate and generate an emergency stop trajectory signal;
generating longitudinal and lateral motion control signals based on normal operating condition local trajectory signals, emergency stop trajectory signals, extreme operating condition trajectory signals, in combination with extreme vehicle state signals;
generating, based on the longitudinal and lateral motion control signals and in combination with the extreme vehicle state signal, control signals for each of the vehicle's actuator mechanisms, and sending them to the corresponding actuator mechanism controllers.
